(19) United States
(12) Patent Application Publication
(10) Pub. No.: US 2005/0065979 A1
(43) Pub. Date: Mar. 24, 2005

(54) System and method for creating and maintaining an online photo album

(76) Inventor: Ivan Vachovsky, San Diego, CA (US)

Correspondence Address: Ivan Vachovsky, 10350 Barnes Canyon Rd., San Diego, CA, 92121, US

(21) Appl. No.: 10/689,874

(22) Filed: Mar. 3, 2003

Related U.S. Application Data
(60) Provisional application No. 60/360,625, filed on Mar. 1, 2002.

(51) Int. Cl. G06F 7/00

(52) U.S. Cl. 707/104.1

(57) ABSTRACT

Provided is a system for making a digital image, stored in a portable memory device, available over a computer network through an online server. The system comprises a computer and a portable memory device reader, communicatively connected to the computer and being connectable to the portable memory device. Also included are an image transfer module, connected to the memory device reader and configured to detect the coupling of the device to the reader and to copy the digital image from the memory device to the computer memory, by way of said reader and a file uploader module, connected to the image transfer module and configured to send the digital image to the online server, connected to the computer network. The system further includes the online server, which is selectively connected to the file uploader module and accepts, stores and makes available over the network the digital image.

This patent application claims the benefit of priority under 35 U.S.C. 119(e) from U.S. Provisional Patent Application Ser. No. 60/360,625, filed on Mar. 1, 2002, entitled “METHOD, APPARATUS AND SYSTEM FOR CREATING AND MAINTAINING AN ONLINE PHOTO ALBUM”, which is hereby incorporated by reference as if set forth in its entirety herein.

### FIELD OF THE INVENTION

The present invention generally relates to Internet related consumer services. In particular the invention relates to a system for transferring pictures, from a portable memory device or a consumer device to the Internet and organizing and managing these pictures on the Internet.

### BACKGROUND OF THE INVENTION

Digital cameras and other consumer devices that take, store and manipulate digital pictures enjoy a rising popularity with consumers. At the same time the internet is becoming a convenient medium for the storage and sharing of personal pictures. Digital cameras are usually bundled with the required equipment and software to upload pictures to a local computer. But publishing these pictures on the internet requires computer knowledge many users may not have, and it also requires that the consumer be able to use space on a webserver, where the pictures are to be published.

Although many companies offer webserver space, choosing the right one may be daunting for the ordinary consumer. When making such a choice the consumer must consider such factors as cost, bandwidth, and privacy. After choosing a webserver the consumer must transfer the pictures from his/her own local computer to that webserver. Doing so requires some knowledge of the local file system on the consumer's computer, a suitable file transfer tool, and the ability to use such tool.

Often the consumer is expected to use proprietary tools, created by the manufacturer of a digital camera in order to upload his or her pictures on the internet. Yet, digital camera manufacturers may not possess the expertise and ability to provide optimal online services. But, their proprietary tools may prevent a third party that possesses the expertise needed to provide optimal online services for digital pictures from providing these services.

Modern consumers are expected to change their digital cameras, because of new purchases, or simply because they are borrowing a friend's camera. But, it is unreasonable to expect them to have to change the way they save and view their pictures, or even give up old family albums with every change of digital camera.

### SUMMARY OF THE INVENTION

Provided is a system for making a digital image, stored in a portable memory device, available over a computer network through an online server. The system comprises a computer having a memory, and a portable memory device reader, communicatively connected to the computer and being selectively coupleable to the portable memory device. Also included are an image transfer module, connected to the portable memory device reader and configured to detect the coupling the portable memory device to said reader and to copy the digital image from the portable memory device to the computer memory, by way of said reader and a file uploader module, communicatively connected to the image transfer module and configured to send the digital image to the online server, connected to the computer network. The system further includes the online server, which is selectively connected to the file uploader module and is configured to automatically accept, store and make available over the computer network the digital image.

Also provided is a method for making a digital image, stored in a portable memory device, available over a computer network. The portable memory device is inserted into a portable memory device reader. The image is read from the portable memory device. The image is copied to computer memory using an image transfer module. The image transfer module resides on a local computer connected to the network. A file uploader module sends the image over a computer network to a an online photo album server, and the image is made available over a network by the online photo album server.

Also provided is a system for making a digital image, stored in an electronic device, available over a computer network through an online server. The system comprises a computer having a memory, an electronic device, capable of storing digital images, which is connected to the computer. Also included are an image transfer module, connected to the electronic device and configured to detect the presence of the electronic device and to copy the digital image from the electronic device to the computer memory, and a file uploader module, communicatively connected to the image transfer module and configured to send the digital image to the online server, connected to the computer network. The system further includes the online server, which is selectively connected to the file uploader module and is configured to automatically accept, store and make available over the computer network the digital image.

### BRIEF DESCRIPTION OF THE DRAWINGS

FIG. 1 is a block diagram representing some of the system modules of the present invention.

### DETAILED DESCRIPTION OF THE PREFERRED EMBODIMENTS

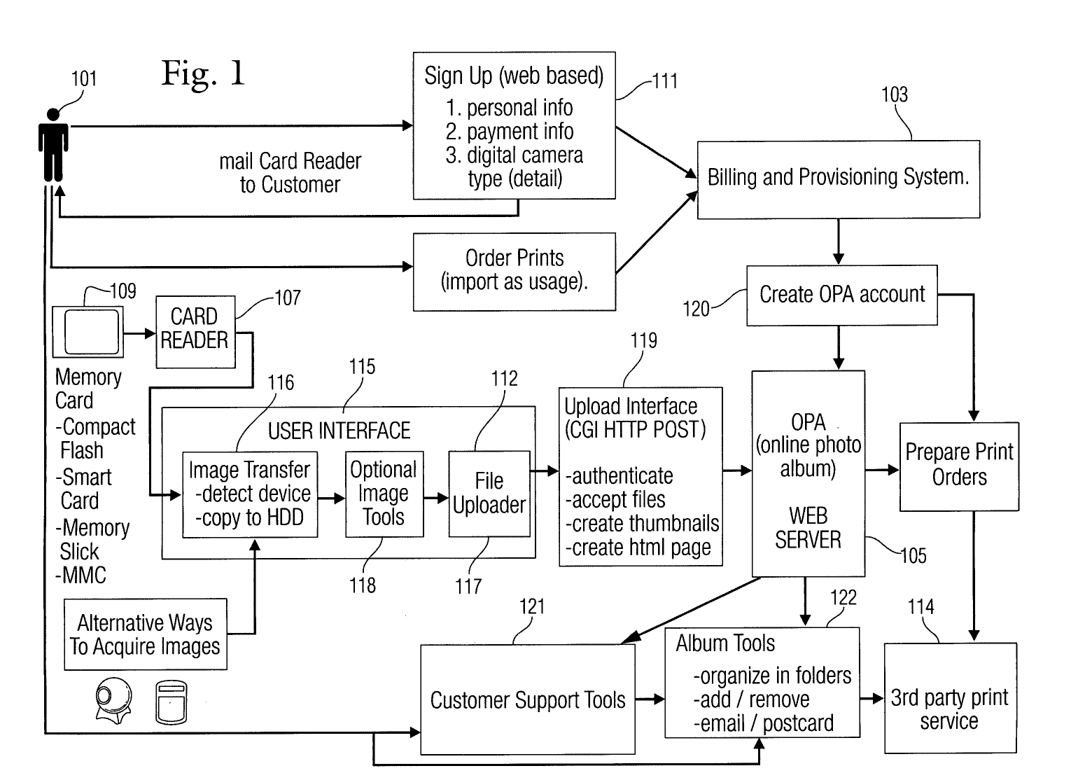

FIG. 1 is a block diagram of a preferred embodiment of the present invention.

A preferred embodiment of the present invention utilizes a customized billing and provisioning system 103 which includes a relational database. It also utilizes a specially configured online photo album web server 105 (the web server).

A preferred embodiment utilizes a generic USB removable memory card reader 107. No additional drivers are required for the later Windows operating systems as “USB removable disk” support is built in for them. When the card reader is plugged in, Windows will show the reader as a drive, with an assigned drive letter (the system may ask for the Windows CD-ROM). Alternative operating systems may require drivers. Some proprietary readers may require drivers as well.

A removable memory card 109 is inserted or otherwise connected to the card reader. In alternative embodiments, any portable memory device and a corresponding portable memory device reader may be used.

In a preferred embodiment a sign-up module 111 is provided and it is implemented as a web based subscription form which communicates with the billing and provisioning system 103 to create an account for user 101 when he or she signs up. The sign up system 111 obtains from the user 101 personal information, service plan choices, billing information and other technical details such as the digital camera type and the memory card type. Also, an account name, password and marketing information may be obtained.

The sign-up module 111 may optionally cause a card reader (or other removable storage device reader) to be mailed to the user 101 after sign-up by sending a message to an appropriate business unit.

Once a user signs up the billing and provisioning system creates a corresponding account for that user in the web server 105. In a preferred embodiment this is accomplished by a separate module—the create an online photo album (OPA) account module 120. This module creates a user account on the web server based on the data received from the sign up module 111. It is implemented as an interface from the billing and provisioning system 103 which creates the account on the web server. The OPA account module passes authentication information associated with the user 101 to the web server 105 as part of the account creation process.

Each account thus created on the web server represents an online photo album. Each such album may contain one or more sub-albums or folders.

The billing and provisional system 103 also handles the billing of users, when necessary. For that purpose the billing and provisioning system communicates with the web server 105 in order to determine users' usage characteristics that may be relevant for billing purposes. The billing and provisioning system also bills customers for ordered prints, if applicable. Billing is preferably done by causing credit card transactions to be created.

An order prints module is also used in preferred embodiments. It is implemented as a web based application which receives an order of prints from user 101 and sends information describing this order to the billing and provisioning system 103. This information will be used to bill the customer for the prints ordered. There are options for different print sizes and the user is able to choose from available standard print sizes, quality, paper type and brand, mounting and framing options.

When prints are ordered the billing and provisioning system 103 obtains the digital images, chosen for printing by the user, from the web server 105 and sends them along with billing and shipping information to a print service. The print service creates the prints and sends them to the client 101.

After signing up, the user executes the user interface 115 on his personal computer or other network connected computing device (user's computer). The user interface may be explicitly installed on user's computer by the user or it may execute as an applet of a webpage the user is viewing. The user interface operates preferably in the background. In a preferred embodiment the user interface includes an image transfer module 116 and a file uploader 117.

The image transfer module 115 is connected to the card reader through a driver or a suitable OS application. It auto-detects a card 109 plugged in the card reader 107, copies the image files to the harddisk and deletes them from the reader. The harddrive copy may serve as a backup in the future. In alternative embodiments other types of computer memory may be used to copy the image onto, such as random access computer memory. Other similar modules can be designed to allow image transfer from alternative devices—handheld Palm or Pocket PC, digital cameras without memory cards, web cams, wireless devices, wrist watches with camera functionality, etc. The image transfer module 116 may be adapted for any devices that have a digital imagery functionality and have the ability to connect to user's computer.

Preferred embodiments may include one or more optional image tools 118. The optional image tools module is invoked on user request, for example by the user clicking on the taskbar icon of the user interface 115. Optional image tools allow the user to manipulate images before they are uploaded to the web server—to change brightness, contrast, resize and rotate. More advanced image manipulation may include “red eye” removal, color balancing, histogram functions. A third party software may be launched in “shell mode” to provide some of this functionality.

The file uploader module 117 uploads images retrieved by the image transfer module 115 and optionally manipulated by the optional image tools module 118 by using the POST method of the HTTP protocol. This module connects to an upload interface application 119 running on the web server 105. Alternative methods for uploading may be used, such as the FTP protocol. The file uploader module must possess an account name and/or password associated with the user 101. This information is either entered directly by the user, or it is previously embedded in a customized copy of the user interface, created for and send to the user.

The upload interface module 119 is used to facilitate image uploads between the file uploader 117 and the web server 105. It is optional, the file uploader may communicate with the web server directly. It is preferably implemented as a CGI application which accepts the files submitted by the file uploader module. It implements user authentication, by matching account names and passwords taken from the web server 105 with those provided by the file uploader module 117. It preferably also has the functionality of displaying an album on a web page, visible to the user and creating updating the web page for the album as new images are uploaded. It also allows the user to designate the album or folders within the album as private (password protected) or public.

A preferred embodiment includes a customer support tools module 121, which allows users to view their account information, view their billing statements and invoices, change payment information (e.g. credit card number) and retrieve lost passwords. This module is preferably web implemented.

In a preferred embodiment the present invention allows the user 101 to upload images in an album. An album is a collection of images which include uploaded photos and data such as titles of photos, descriptions of photos, dates and times photos were taken, category, size, dimensions, resolution and quality of photos. Albums offer the ability to search and order images by different criteria. Users are able to customize albums by changing colors, backgrounds, fonts and text descriptions. Albums may further contain sub-albums, or folders, which comprise sets of pictures with accompanying additional data, and have functionality similar to that of albums. Different sub albums and folders within an album may have different security settings.

An album tools module 122 is preferably provided. It is implemented as a set of web based CGI applications that allow the user to manage his or her albums—add or remove images, move images between albums, create or delete albums, change the album text descriptions, password protect albums, etc. Other tools include image manipulation, such as changing brightness, contrast, resizing and rotating, album tools are preferably implemented on the web server 105.

In addition, the album tools may provide: interface-for sending the images, with different messaging services For example, images may be send as e-mail postcards, faxed through a fax gateway, sent as messages to mobile devices like wireless phones, or downloaded to devices such as electronic frames or handheld computers. Thus the album tools module 122 may be used in a way similar to the order prints module 112.

While this invention is described with reference to a personal computer, it may be used in conjunction with any other kind of computer, or computing device that is able to store and run the code of the user interface, possesses memory that is sufficient to store digital images, and is able to communicate using a computer network. For the purposes of this application this device will be referred to as a computer.

The invention has been described in connection with a particular embodiment but is defined without limitation by the claims appended hereto and includes insubstantial variations in elements and method steps.

1. A system for making a digital image, stored in a portable memory device, available over a computer network through an online server comprising:
a computer having a memory;
a portable memory device reader, communicatively connected to the computer and being selectively coupleable to the portable memory device;
an image transfer module, connected to the portable memory device reader and configured to detect the coupling of the portable memory device to said reader and to copy the digital image from the portable memory device to the computer memory, by way of said reader;
a file uploader module, communicatively connected to the image transfer module and configured to send the digital image to the online server, connected to the computer network; and
the online server, being selectively connected to the file uploader module and being configured to automatically accept, store and make available over the computer network the digital image.

2. The system of claim 1 further comprising a billing and provisioning system, connected to the online server and including a relational database, the billing and provisioning system being configured to store user accounts in the database.

3. The system of claim 1 wherein the online server includes one or more albums, each album being associated with a single user, and wherein at least one album includes a folder.

4. The system of claim 3 further comprising an album tools module which allows a user to manipulate, delete, and create folders in an album that is associated with the user.

5. The system of claim 4 wherein each folder possesses distinct privacy settings.

6. A method for making a digital image, stored in a portable memory device, available over a computer network comprising the steps of:
inserting the portable memory device into a portable memory device reader;
reading the image at the portable memory device;
copying the image to computer memory using an image transfer module, residing on a local computer connected to the network;
sending the image over a computer network to an online photo album server by a file uploader module; and
and making the image available over the computer network by the online photo album server.

7. The method of claim 6 further including the steps of creating a photo album in the online server by a user.

8. The method of claim 7 further including the step of placing the image in the photo album.

9. The method of claim 7 further including the step of deleting a photoalbum.

10. A system for making a digital image, stored in a portable memory device, available over a computer network through an online server comprising:
a computer having a memory;
an electronic device, communicatively connected to the computer and being capable of storing digital images;
an image transfer module, connected to the electronic device and configured to detect the presence of stored digital images in the electronic device and to copy the digital images from the electronic device to the computer memory, by way of said reader;
a file uploader module, communicatively connected to the image transfer module and configured to send the digital image to the online server, connected to the computer network; and
the online server, being selectively connected to the file uploader module and being configured to automatically accept, store and make available over the computer network the digital image.

11. The system of claim 10 wherein the online server includes one or more albums, each album being associated with a single user, and wherein at least one album includes a folder.

12. The system of claim 11 further comprising an album tools module which allows a user to manipulate, delete, and create folders in an album that is associated with the user.

13. The system of claim 4 wherein each folder possesses distinct privacy settings.
